(19) United States
(12) Patent Application Publication
(10) Pub. No.: US 2015/0081259 A1
(43) Pub. Date: Mar. 19, 2015

(54) METHOD OF CALIBRATING A GEOLOGIC MODEL

(71) Applicant: Roxar Software Solutions AS, Stavanger (NO)

(72) Inventors: Garrett LEAHY, Stavanger (NO); Erik NILSEN, Oslo (NO); Alexander BUKHGEYM, Oslo (NO); Thomas BERG, Oslo (NO); Wenxiu YANG, Oslo (NO)

(21) Appl. No.: 14/477,524

(22) Filed: Sep. 4, 2014

(30) Foreign Application Priority Data
Sep. 17, 2013 (NO) 20131246

(51) Int. Cl. G06F 17/50; G01V 1/28

(52) U.S. Cl. CPC G06F 17/5009; G01V 1/28
USPC 703/2; 703/6

(57) ABSTRACT

Method of providing a geologic model (1′) representing a geologic feature based on geologic measurement data, such as seismic or electromagnetic data. The method comprises the following steps determining an initial model estimate. Further the method comprises, by means of a metric function, comparing features of a plurality of candidate traces (19) with known features of a model control point (3). For the candidate traces (19) where the metric function returns a similarity value above a similarity metric threshold, a model guide point (9) is arranged on the candidate trace (19) in question. The geologic model (1, 1′) is adjusted towards or onto such model guide points (9).

This invention relates to the field of subsurface mapping as commonly used in resource exploration, specifically interpretation of geophysical data. It falls within the class of interpretation tools typically known as auto-tracking technologies. Geophysical data typically includes data resulting from seismic or electromagnetic surveys.

### BACKGROUND

Geologic interpretation is a time consuming and labor intensive task, but it is required in order to produce detailed descriptions of the subsurface for use in commercial decision making in hydrocarbon exploration and production, for instance. In particular, operators have varying requirements for the level of detail in their geologic interpretations, and need an efficient way to obtain this information. In typical subsurface mapping applications related to extractive industries or hazard assessment, seismic data is usually the data of choice; and much of the prior art refers to methods of seismic interpretation. However, interpretation workflows can also include interpretation of other geologic data used in the industry, for example, electromagnetic data, gravity data, etc.

In seismic data, each trace is an individual measurement of vertical impedance structure. Auto-tracking technology is used to streamline the interpretation process by letting the computer guess which positions in a seismic image most closely resemble the interpreter's desired structure. This is accomplished by letting the interpreter place a seed point on an individual trace; adjacent traces are then compared to the seed trace to determine some metric of similarity. Then, the computer estimates which location on the adjacent trace most closely resembles the seed point. A common auto-tracking workflow is diagrammed in FIG. 2.

The conventional solution creates several challenges: 1, the solution is local, not global. If the tracker cannot find an adjacent trace of sufficient similarity, then tracker aborts. 2, the solution is prone to cycle skipping across faults (ie, the auto tracker can have difficulty moving across faulted structures), requiring extensive quality control. 3, tracking is difficult when data quality degrades, resulting in the tracker aborting. Therefore, auto-tracking only works well when the quality of the background geologic data is of sufficient quality. When the geologic image is not clear, similarity metrics fail and the tracking job will stop. Also, when the reflections are not continuous (as in complex fault systems) artifacts are created due to the cycle. Substantial effort is usually expended to quality-control the results of auto-tracking algorithms by the removal of or correction of poorly tracked points.

There are many examples in the prior art relating to auto-tracking seismic data. For example, Flinchbaugh (U.S. Pat. No. 4,633,401) discloses a method for identifying events in 3D seismic data. In this method, he identifies turning points in the seismic data (zero crossings in the Nth derivative) on a starting (seed) seismic trace and compares this trace to adjacent traces to identify which turning points correspond. In this way, a particular turning point identified with a seismic event can be tracked across a 3D seismic volume. This provides an estimate of location for the seismic event, which can then be identified with a geologic horizon and used for hydrocarbon prospecting and production. This disclosure covers the general workflow for mapping seismic events throughout a 3D workflow automatically from a starting trace.

Unfortunately, in many cases seismic data is complex, and this method fails if a successful match between adjacent traces is not made. Waveform changes due to changes in frequency content, environmental noise, migration artifacts, changes in geologic impedance properties, and large scale geologic structure such as faults make determining similarity difficult between traces. Flinchbaugh's method does not address these complications. Further, seismic data and wavelets have generally periodic properties, and therefore comparing traces can be subject to cycle skipping, where for example the similarity calculation may have multiple plausible candidates for tracking to an adjacent trace.

Howard (U.S. Pat. No. 5,056,066) also discloses a method for tracking a seismic event through a cube of 3D seismic data. This method follows the general workflow outlined by Flinchbaugh (U.S. Pat. No. 4,633,401), and uses a metric of waveform similarity rather than simply matching seismic turnings. This method is iterative and uses an acceptable tracked trace as a seed trace for the next comparison. This method also can have difficulty when faced with changes in seismic data, like varying impedance contrast, data noise, or changes in structural data. All of these effect the robustness of the similarity metric.

Hildebrand (U.S. Pat. No. 5,153,858) discloses a method for finding horizons in 3D seismic data. Here, seismic events are digitized trace-by-trace into a binary data series, with a “1” representing the presence of a seismic reflection. Then, a seed bit is selected, and adjacent traces are scanned to determine the presence of the event in adjacent portions of the volume. This technique is limited by the ability to determine similarity only between a binary series, which does not represent the full complexity of the seismic waveform. The scanning process is also limited by complexity in the geology, which can make similarity calculations fail.

Hildebrand et al (U.S. Pat. No. 5,251,184) propose a similar technique based on the disclosure of Hildebrand (U.S. Pat. No. 5,153,858). It also is founded on the conversion of seismic data into a binary series, again limiting the utility by discarding extraneous information contained in the seismic waveform.

Hildebrand (U.S. Pat. No. 5,432,751, continuation, U.S. Pat. No. 5,615,171) proposes a method for mapping horizons from a seed point; in this method, however, the tracked seismic event is called a child of the generating parent seed point. By preserving this information, the author claims a method for obtaining a seismic horizon from multiple seed points. This method can overcome some of the difficulties associated with poor data because additional seed points can be placed when the original tracking fails. However, this technique can still be disrupted by poor data, cycle skipping, or complicated geology.

Sitoh (U.S. Pat. No. 5,537,365) discloses a method for evaluating the quality of horizon picks generated by automatic picking of 3D seismic data. In this method, additional steps are added to help monitor and control the quality of the similarity output; for example, a time window is given, and similarity is only accepted for further picking if it is within the proposed window. While providing useful feedback on the quality of the tracking, this method does not improve the ability of conventional tracking methods (described above) or influence their ability to handle complex seismic waveforms.

Venkatraman (U.S. Pat. No. 5,570,106) provides a method for creating horizons from 3D seismic data. In this method, after an initial scan of a seismic volume, a sub region is selected for deletion from the tracked data. The tracked points are removed inside this region. Subsequently, the combined region is re-tracked using the remaining tracked points as seed points for s second iteration. While this is claimed to produce improved fidelity to the seismic data, this results only from the large number of initial seed points that can be used as comparison. It does not allow for tracking of horizons through complex geology or poor data regions.

Sitoh (U.S. Pat. No. 5,675,551) discloses another method for developing 3D seismic horizons using tracking technology. This disclosure is founded on the technology developed previously (Sitoh, U.S. Pat. No. 5,537,365), but additionally requires the interpreter to designate a path between a seed trace and a target trace, and picking is performed along each link in the designated path. This method requires the interpreter to designate a path for each target trace, potentially dramatically increasing the interactivity of the tracking algorithm. This method continues to fail in regions where poor data, cycle skipping, or complicated geology are prevalent.

Klebba and Van Bemmel (U.S. Pat. No. 6,016,287) describe a method for automatically mapping a horizon in 3D seismic data. Here, the volume is scanned for a best sample that matches the seed trace. Then, adjacent traces are searched via bisection between seed points and the best sample to obtain intermediate horizon points. This method also suffers from the typical problems of auto-tracking technology, in that it is challenged by poor data regions and complex geology. In addition, it is even more prone to cycle skipping in that bisection can yield positive similarity even if the geology has substantially changed between the seed points and the best sample.

Alam (U.S. Pat. No. 5,432,751) discloses a method for mapping horizons in 3D seismic data. In this method, seismic data and seismic attribute cubes are combined in linear combination in such a way that the characteristic signal-to-noise ratio of the combined volume is improved over conventional seismic volumes. This allows an algorithm to quickly determine a set of points spanning traces that best represent a particular horizon. Unfortunately, this method does not actually help the interpreter map the horizon, only produces more interpretable data. Further, these volumes are subject to the standard pitfalls of automatic horizon mapping, but additionally to the added complexity of having multiple independent attributes cause distortion in the volume to be mapped.

Cacas (U.S. Pat. No. 7,257,488) discloses a method for seismic interpretation by estimation of chronological scenarios of sedimentary layers deposition. This method is an iterative method in which the oldest reflectors across a volume are indexed first, followed by progressively younger reflectors. Unfortunately, to be accurate this method requires analysis of the entire seismic volume, which can be computationally expensive and can lead to inaccuracies. Further, poor data quality leading to the inability to index reflectors will impact the accuracy of the indexing scheme.

Fitzsimmons and Thompson (U.S. Pat. No. 7,283,911) present a method for interpreting reverse faults and multiple z-valued horizons. This method is not specifically related to how to automatically pick seismic data, but rather to a data analysis method that can tolerate multiple z-valued horizons commonly seen in folding or reverse faulting geometries. This disclosure therefore does not address how to actually make interpretations automatically across seismic data cubes, and is limited by data quality, cycle skipping, and geologic complexity as described above.

Tnacheri and Bearnth (U.S. Pat. No. 7,519,476) disclose a method for tracking a horizon in 3D seismic volumes. In their method, a series of genotypes are developed based on characteristics of a data volume or data attribute volume, merging these genotypes to create a combined characteristic indicative of a seismic horizon, and using this merged genotype to perform analysis of data and attribute traces in the region of interest. Similar to the disclosure by Alam (U.S. Pat. No. 5,432,751), this procedure does not necessarly avoid the difficulties associated with tracking just seismic data—geologic complexity, waveform complexity, and low data quality all make contributions to amplitudes in attribute cubes, and therefore these effects are carried on through the similarity analysis, leading to poor tracking.

Lomask et al (U.S. Pat. No. 7,769,545, U.S. Pat. No. 7,769,546) propose a method for interpreting 3D seismic cubes. Their method relies on existing horizon tracking technology as described here, and additionally makes adjustments to the seismic data to make iterative tracking of subsequent horizons more robust. They modify the seismic data iteratively such that the geologic structure is “flattened”, leading to increased coherence between adjacent seismic traces, and therefore a better ability to track a subsequent seismic event. Unfortunately, while this accounts for some geologic complexity, it still falls victim to data quality and waveform issues. Further, incorrectly flattened data may lead to artifacts in the resulting horizons.

More recently, Leahy et al describe in Norwegian patent applications NO20121473 and NO20121472 a method for interpretation of geophysical data that combines estimates of uncertainty input by the interpreter with a modeling workflow that produces geologically consistent reservoir models. The present disclosure builds on this technology in the best mode.

### SUMMARY OF THE INVENTION

According to the invention there is provided a method of providing a geologic model representing a geologic feature based on geologic measurement data. Typically such geologic measurement data can be seismic or electromagnetic data. The method comprises the following steps:
a) determining an initial model estimate; and
b) by means of a metric function comparing features of a plurality of candidate traces with known features of a model control point. For the candidate traces where the metric function returns a similarity value above a similarity metric threshold, a model guide point is arranged on the candidate trace in question (for which the comparing was performed). Moreover, the geologic model is then adjusted towards or onto such model guide points.

A geologic feature can be any type of subterranean formation, typically a horizon or a fault, which may be found by means of a geologic survey, such as a seismic survey.

In one embodiment of the method, step a) comprises determining a data search window that envelopes the initial model estimate, and in step b) comparing the control points only with candidate traces that are within the data search window.

According to embodiment, the user may determine a data search window which in time or depth is fixed laterally. In other embodiments he may choose a data search window that in time or depth varies laterally.

Preferably, step a) can comprise positioning the initial model estimate across one or more model control points.

Step b) can advantageously involve ignoring locations for which the metric function returns a similarity value below the similarity metric threshold. Hence, such candidate traces will then not be used to adjust the geologic model.

In such an embodiment, at locations where the metric function returns a similarity value below the similarity metric threshold, the geologic model can be adjusted by means of interpolation between model guide points and/or model control points. This is one manner of adjusting the geologic model also in regions where geologic measurements are not applicable for such adjustment.

Step b) can comprise, by means of said metric function, comparing separate candidate traces with a plurality of model control points and then producing a model guide point at the point of any candidate trace where the metric function results the highest similarity value, if above said similarity metric threshold. In this manner a candidate trace is linked to the one control point to which it exhibits the most similarity.

Other embodiments of the invention will appear from dependent claims and this description.

Thus, the method regards a method of auto-tracking seismic horizons. In this method the user first builds a smooth geologic model using model control points (described in more detail in previous disclosures). According to the method, the smooth model is used as a constraint/guide for the data calibration. This provides a set of detailed, high resolution model guide points (FIG. 1). Further calibration can continue via the addition of new control points, added by the user, to shape the geologic model. After any number of iterations, the user can calibrate the updated model with the geologic data. This permits a global solution to the tracking problem, even in the presence of faults, bad data, or poor correlation. The method can also use model uncertainty envelopes to define the search area for correlations, giving the user better control over the accuracy of their results.

This method is different than conventional tracking approaches in that it requires an initial, global estimate of geologic feature position, and in the best mode leverages the availability of uncertainty information to guide the search for the event locations that best match the seed point(s).

Compared to conventional auto-tracking technology, the method has several advantages. First, the method provides a global solution as it does not need to abort if it fails to find a sufficient quality match to the seed trace. Second, the method is implicitly capable of handling complex geometries where auto-tracking fails. This is because in the best mode, it uses a geologically consistent smooth model that can contain features such as faults or truncations. Third, data quality control is greatly simplified, as the global solution means that any low-quality individual model guide point cannot derail the method. Therefore much higher similarity tolerances can be used to provide high quality matches for model building. Fourth, the method leverages uncertainty estimates associated with the smooth model to define a search window: regions of the model with high certainty will yield high quality matches, and regions of the model with low certainty will search more broadly. Finally, the method directly results in a highly detailed reservoir model, rather than a set of points or surfaces that can be combined in a separate reservoir modeling workflow.

It should be clear to the reader that while in general this workflow is intended to be implemented via software on a computer or computing system, this disclosure covers all embodiments including manual or paper-based implementations.

Typical geologic data used in the method according to the present invention is seismic data. However the method is not limited to seismic data, but may also involve electromagnetic data or other types of data resulting from subterranean surveys.

### BRIEF DESCRIPTION OF THE FIGURES

FIG. 1: Workflow diagram for model driven seismic conditioning and derivative workflows;

FIG. 2: Idealized workflow diagram for conventional auto-tracking technologies;

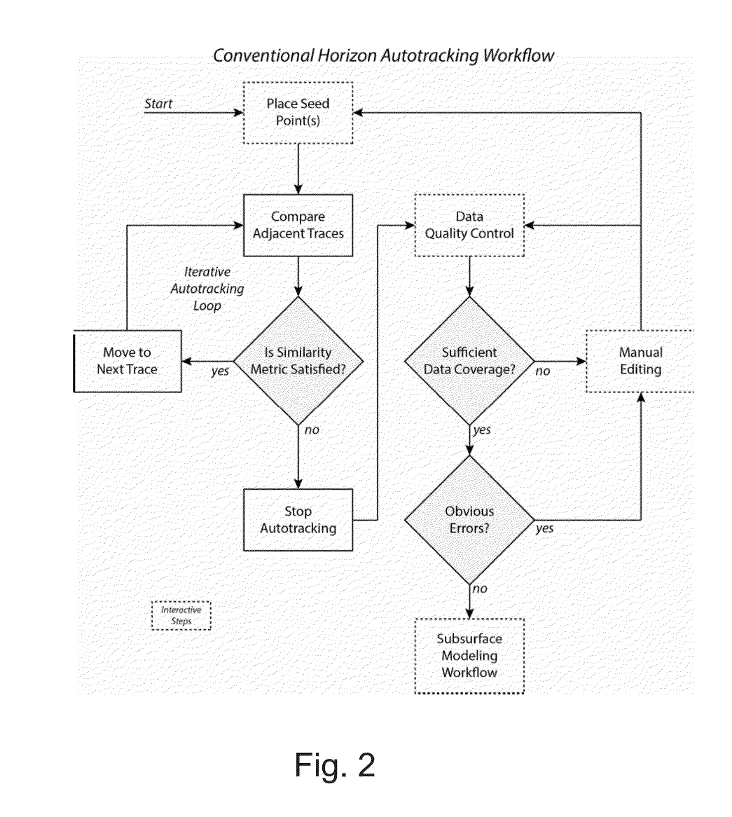

FIG. 3: Cartoon of typical geologic structure with seismic response plotted in the background;

FIG. 4: Cartoon of a smooth model constructed based on a seed point, with uncertainty estimate;

FIG. 5: Cartoon showing a possible similarity search window associated with the smooth model;

FIG. 6: Cartoon showing new detailed model that matches the background seismic data;

FIG. 7: Real-data example of smooth model with real seed points (top—cross-section view, bottom—3D surface view);

FIG. 8: Real-data example of resulting detailed model with real seed points (top—cross-section view, bottom—3D surface view);

FIG. 9: Real-data example of detailed model tracking across a fault (steeply dipping lines); and

FIG. 10: Real-data example of detailed model with masking polygons to stop tracking (top—cross-section view, bottom—3D surface view).

### DESCRIPTION OF AN EMBODIMENT OF THE INVENTION

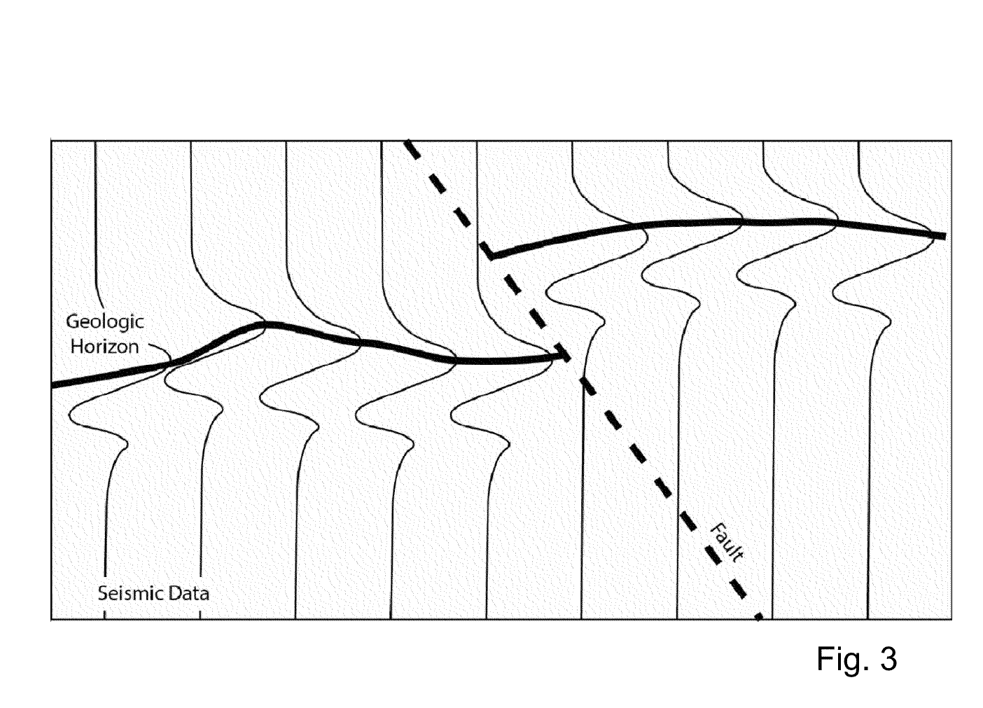

While the general features of the invention is presented above, a detailed, non-limiting example of embodiment is presented in the following. A method according to the invention is described, for automatically interpreting geologic features in seismic or other geophysical data. FIGS. 3-6 provide conceptual illustrations of the workflow to help the reader follow the description. However the method applies to a broad range of geologic situations and the figures should not be implied to limit the scope of the method's applicability.

FIG. 3 shows a cartoon geologic scenario with two geologic features, a horizon and a fault. The anticipated seismic response to this scenario is illustrated in the background by the presence of seismic traces, with peaks in the traces where the horizon is present. The seismic data provides a representation of the geologic features, the accuracy of which is limited by effects beyond the scope of the present disclosure; the purpose of interpretation is to infer an estimate of feature position from the data. For the purposes of this disclosure, we refer to the estimate of the position of the geologic feature as a geologic model. This is typically a three dimensional surface in the domain of interest describing estimated coordinate positions (lateral and vertical) of the feature of interest.

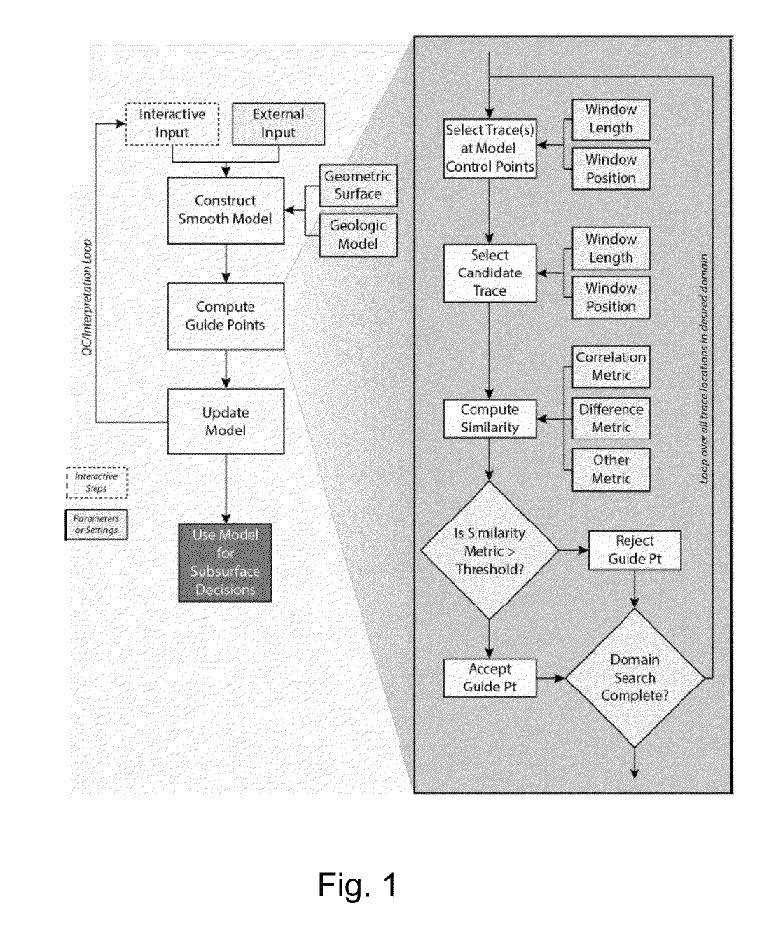

The method consists of two fundamental steps (FIG. 1): first, a global estimate of the geologic feature's position is estimated (called “smooth geologic model”, or “smooth model”). While it is called “smooth” because it is anticipated in most cases that the initial geologic model will have limited variability and roughness, this is by no means a prerequisite for the workflow; a geologic model with any properties can be used. By global, it is meant to indicate the domain of investigation, for example, the area spanning a prospect, leasing block, or seismic survey. In general, the size of the domain of investigation is limited only by the data coverage and analysis system resources (for example, computer hardware such as processor speed, memory and storage, or visualization ability). In practice, the domain size may be some subset of the region spanned by seismic data, or, whatever region the user finds to be most convenient for analysis (as guided by their individual work practices).

The smooth model may be generated based on any pre-existing external input. For example well markers, previous interpretation points, or other user input. Alternatively, the user may choose to add model control points (i.e., a set of measurements that define the geologic model) interactively during the interpretation process. In the preferred embodiment, the smooth model is generated mainly via interactive input, i.e. a user places one or more model control points, and a global surface (a global model) is generated that fits the model control points at the given location.

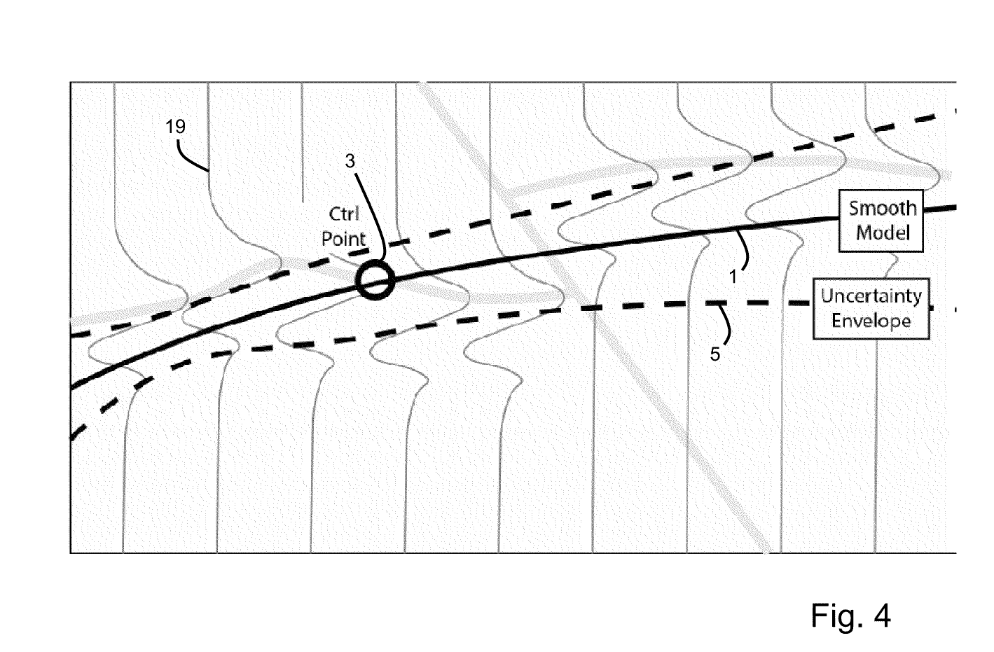

In this embodiment the initial model estimate is in the form of a smooth geologic model. FIG. 4 shows a cartoon example of a smooth geologic model 1 satisfying a single control point 3. The smooth model 1 may or may not accurately represent the data in detail. In general, the smooth model 1 is expected to have similar characteristics to the geologic data, but not represent perfectly.

In the preferred embodiment, the smooth model 1 has a spatially varying uncertainty associated with it. This uncertainty is the interpreter's best estimate of the uncertainty associated with the model's position as derived from a variety of data attributes. Such data attributes includes, but is not limited to, data quality, frequency content of the seismic data, noise, or migration artifacts. These attributes all contribute in various ways to ambiguity in how the seismic data represents the subsurface structure. Exact methods for choosing uncertainty envelopes will depend on the specific data being interpreted and the user's preferences or best practices. An uncertainty envelope 5 is also shown in FIG. 4.

A final characteristic of the smooth model is how it is constructed. Many examples of surface interpolation exist in the prior art, for example, cellular extrapolation (triangles, rectangles), smooth or rough surfaces interpolated via nearest neighbor approaches, or global or local b-spline methods. These methods are called “geometric” methods. These and other algorithms have properties that users may find impact the quality of their results in different circumstances. The specific choice of interpolation algorithm has no impact on the method according to the invention discussed here.

An improvement to geometric methods is to include a set of constraints on model building based on geologic rules. In this manner, rules such as fault truncation and offset, on-lap, erosion, or other geologic concepts can be incorporated into the model building process. The addition of geologic rules when building the smooth model provides distinct advantages over conventional auto-tracking technology. For example, the model can include offset across a fault and therefore result in improved tracking quality (less prone to cycle skipping) in these regions where traditional methods fail. Further, in an on-lap situation where one horizon merges into another, the presence of geologic rules can alert the tracking system and stop the creation of guide points when the surfaces approach. The method according to the present invention does not depend explicitly on the precise choice of geologic rules. Rather it could be applied with any set of rules. It is believed that the best implementations of these algorithms will include some sort of geologic constraints on model building.

The second step in the method is to compute model guide points 9 that can be used to enhance the detail of the smooth model 1 (FIG. 1). The method can be compatible with any specific algorithm for determining these guide points, though a specific embodiment is described here. It is anticipated that methods that make use of the existing smooth model will be most successful at addressing the problems encountered by traditional auto-tracking technology.

Seismic data is typically stored as “cubes” of traces, with a trace in time or depth at each horizontal (x,y) location in the cube. Here, control traces 13 are selected at the control points 3 used to build the smooth model 1. At this stage in the method, the model control points 3 can be thought of interchangeably with seed points as described in the prior art. While the whole data trace could be used for the similarity metric, the method may advantageously include to window the data before the computations. This reduces the impact of seismic events far from the region of interest when computing guide points. Such an embodiment of the method is independent of functional form for the window, and any of the typical signal-processing windows may be used. Typically a tapered box-car may be used to give the best results. A window position must also be chosen, but again, it does not impact the embodiment of the method described, only the quality of the final results. The window may be centered on the seed/control point 3. However applications could be conceived where the search window 7 is offset vertically from the smooth model 1. It should be noted that these parameters apply only to the seed/control trace 13.

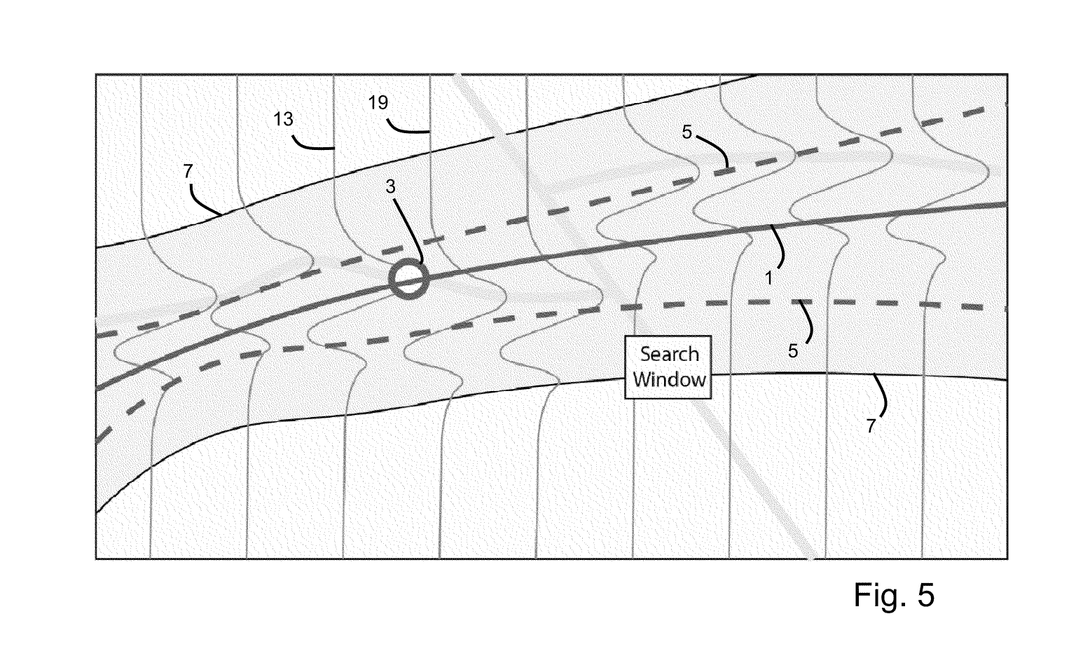

Next, a candidate trace 19 must be selected from anywhere in the seismic cube. This candidate trace 19 should also be windowed before the similarity metric is applied, though there is no requirement that the window function used for candidate traces 19 resemble that used for control traces 13. Again, the method is independent of precise functional form of the window and its parameters as described above. However, here it is believed that the best results are achieved if the window 7 is derived from the smooth model 1 and its associated uncertainty (FIG. 5). For example, it is expected that the window should be centered at the vertical location where the smooth model 1 crosses the candidate seismic trace 19. Further, it is possible that the interpretation uncertainty can impact the quality of the similarity metric, and that the window length should be related. Typically one may expect users to want to search the seismic trace for guide points between two to four uncertainty envelopes from the smooth data for optimal results. However, the exact choice will most certainly be application and data specific.

Finally, the windowed control trace 13 and the windowed candidate trace 19 should be compared using a similarity metric. Many metrics are known and disclosed in the prior art, and any of them are suitable for use in the method according to the invention. It is anticipated that most users will choose a correlation or a difference metric (for example, a Euclidian norm). These metrics can be sensitive to key characteristics of the seismic waveform, and can therefore result in guide points 9 that are most like the control point 3. While in most circumstances the similarity metric will yield some measure of similarity between the control trace 13 and the candidate trace 19, certain cases exist in which the computation fails. In these cases, the candidate traces 19 are subsequently ignored.

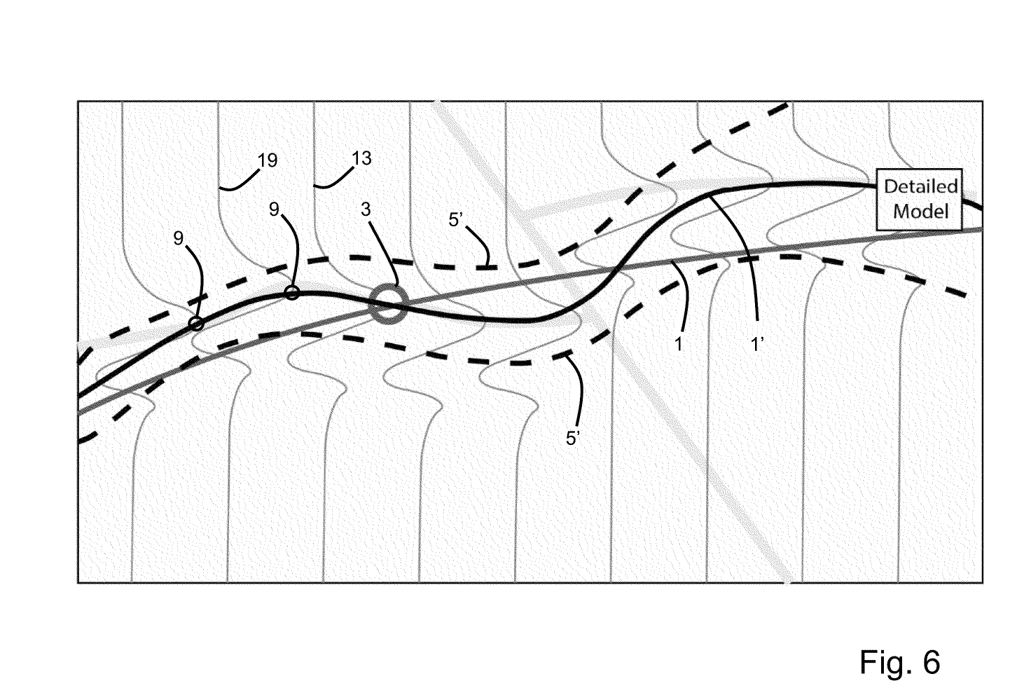

Guide points 9 are then accepted or rejected based on a similarity metric threshold that is determined a priori by the user. While conventional auto-trackers eventually stop if no suitable adjacent candidates are found, the method according to the invention proceeds until the entire domain has been searched for candidate traces 19. When complete, all guide points 9 for which the similarity metric returns a similarity value that are above the similarity metric threshold are used with the initial control points to build an updated geologic model 1′ (“detailed model”, FIG. 6). Where no guide points 9 are present, the surface generation algorithm simply interpolates. This yields a global geologic model 1′ of a geologic feature with detail provided by both the model control points 3 and the model guide points 9 with sufficient quality.

In regions with multiple model control points 3, a different approach might be taken in order to obtain a stable solution. For example, a candidate trace 19 could be compared only to the nearest control traces 13. Or the candidate trace 19 could be compared to one or more control traces 13, and the result with the highest similarity value could be stored as the result for that candidate trace 19. If this result is above the predefined similarity metric threshold, a guide point 9 is provided at that candidate trace 19.

The user may find in practice that their results are improved by providing further input to the algorithm. In this case, the user may choose to provide additional control points 3 and run an additional iteration of the workflow. The “smooth model” for a subsequent iteration may be based only on the previous input with the new interactive input, or may include information or guide points from the previous iteration's resulting detailed model 1′.

From a practical standpoint, the global approach solves many challenges associated with conventional workflows. However, situations may exist in which the user wishes to limit the domain that is searched for guide points. For example, conditions may exist that limit data quality (and therefore interpretability) in a well-defined sub-region of the domain. In this case, the user may choose to delineate this sub-region via a masking polygon. The method may be extended to exclude traces within the masking polygon from the search domain.

Additionally, data quality may degrade, or interpretation may be challenged in proximity to geologic features (for example, fault shadows, intrusions, or horizon truncations). The method can be extended to include a filtering step to exclude candidate traces within some specified envelope of the geologic feature. Both of these enhancements to the method serve to streamline the construction of the geologic model and the model quality control process.

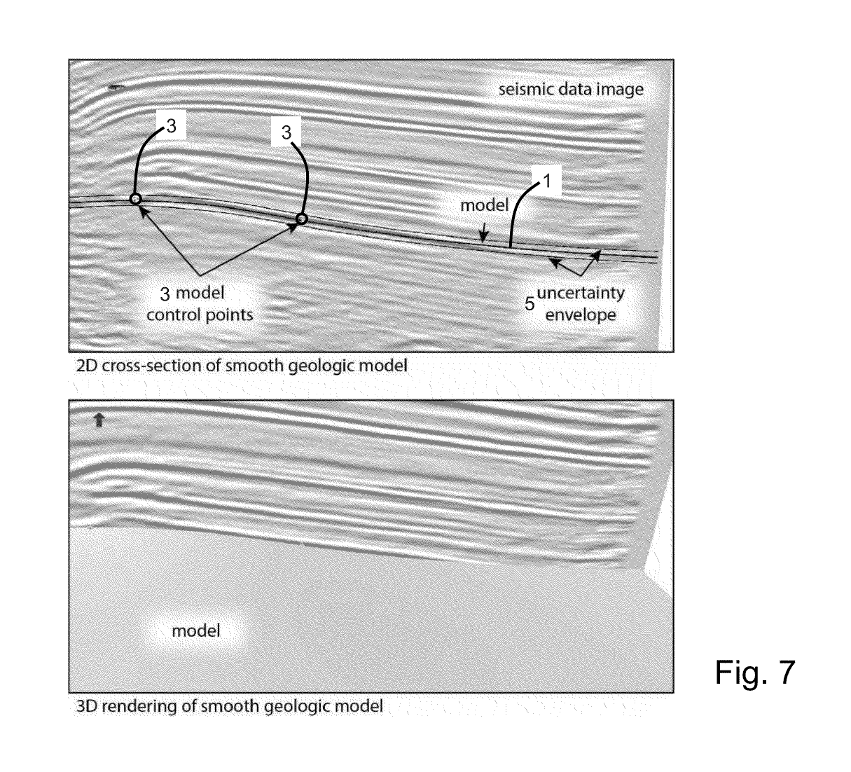

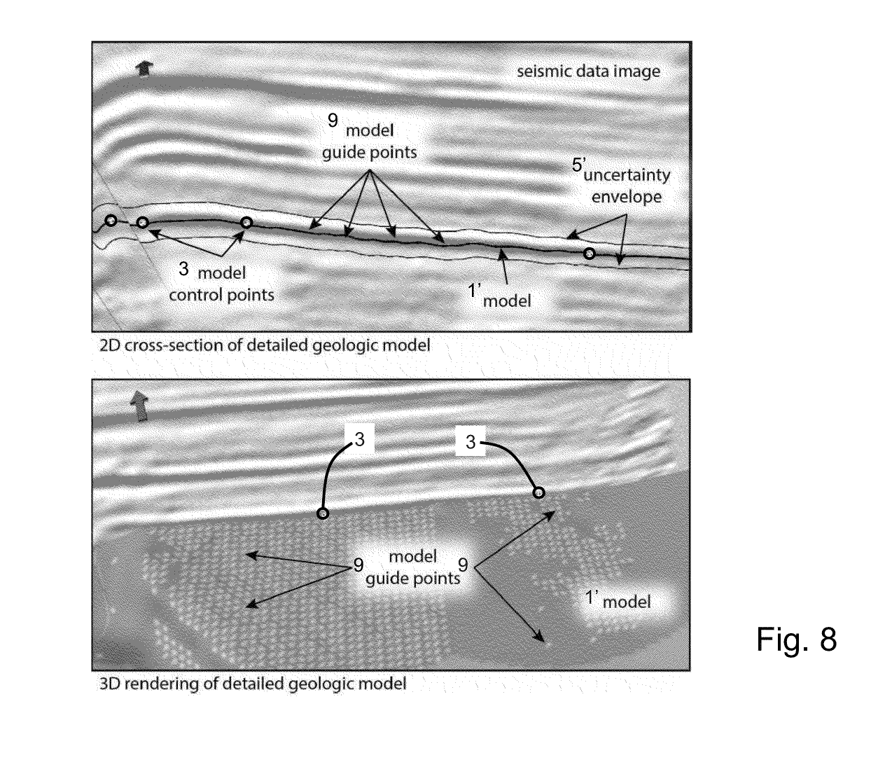

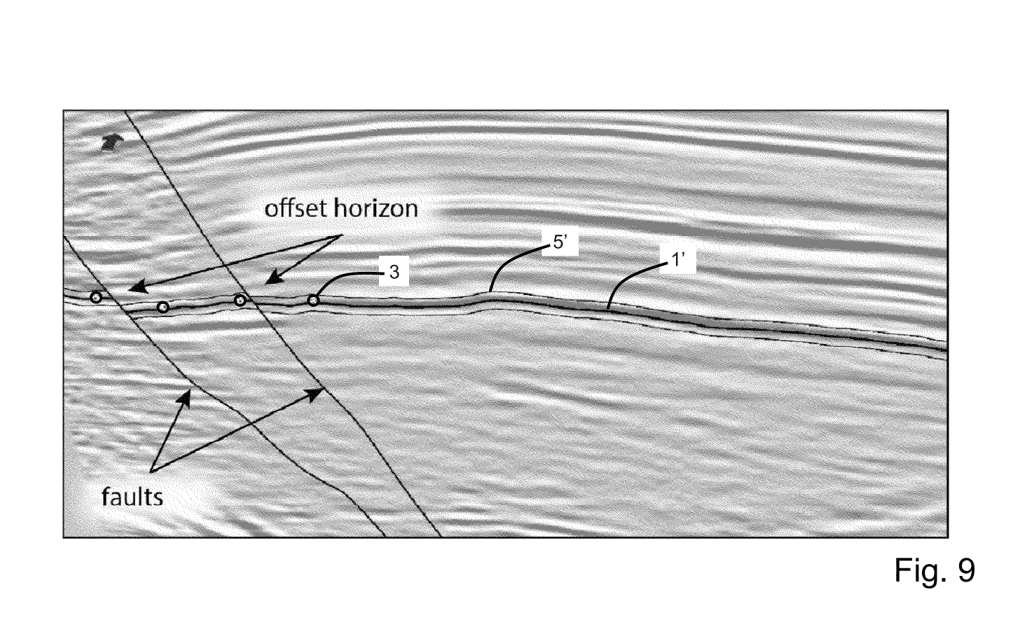

In FIGS. 7-10 are shown examples of this method working in practice with real seismic data. The seismic data is from Teapot Dome, provided by the Rocky Mountain Oil Field Testing Center for public use. In FIG. 7, an initial model estimate 1 in the form of a smooth model is constructed from several model control points 3. The smooth model 1 has an associated uncertainty, and is a global, 3D surface. FIG. 8 shows the detailed model 1′ resulting from the application of this method. The surface is shaded with light grey to indicate successfully found guide points. FIG. 9 shows a detailed model 1′ obtained by this method that is not impeded by the presence of faults in the geologic section (steeply dipping lines).

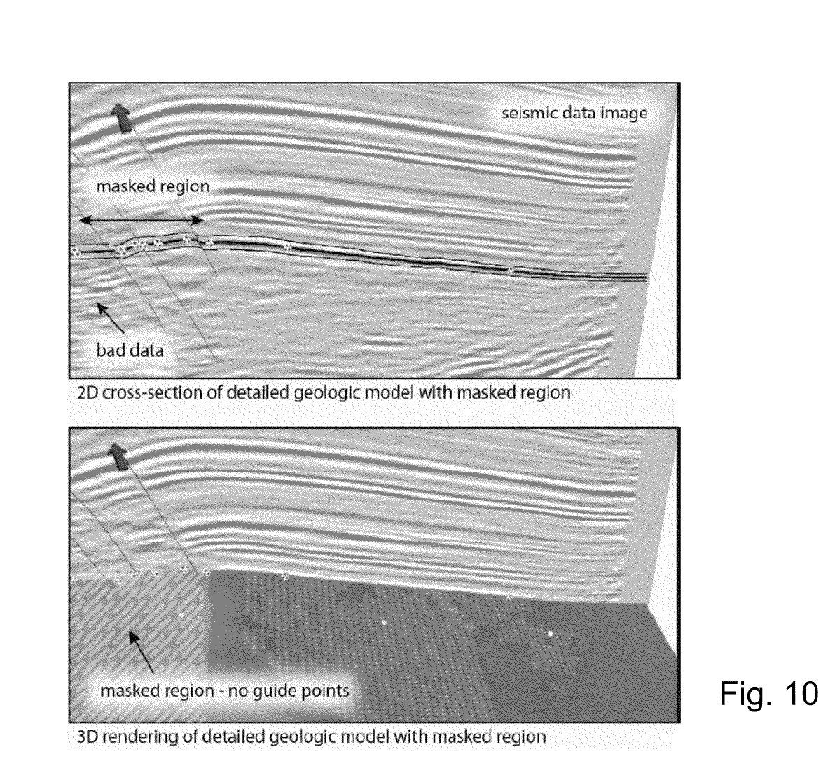

FIG. 10 shows an application of the method in which a portion of the domain is masked due to poor data quality. In this region of poor data quality no guide points are computed, resulting in a more streamlined workflow without an additional quality control step.

### LIST OF REFERENCE NUMBERS

1 Initial model estimate (“smooth geologic model” in described embodiment)

1′ Adjusted geologic model (“detailed model”)

3 Control point

5 Uncertainty envelope

5′ Adjusted uncertainty envelope

7 Search window

9 Model guide point

13 Control trace

19 Candidate trace

1. A method of providing a geologic model representing a geologic feature based on geologic measurement data, the method comprising:
a) determining an initial model estimate; and
b) via a metric function, comparing features of a plurality of candidate traces with known features of a model control point, and for the candidate traces where the metric function returns a similarity value above a similarity metric threshold, arranging a model guide point on a candidate trace in question, and adjusting the geologic model towards or onto such model guide points.

2. The method according to claim 1, wherein step a) comprises determining a data search window enveloping an initial model estimate, and in step b) control points are compared only with candidate traces within the data search window.

3. The method according to claim 1, wherein step a) comprises positioning the initial model estimate across one or more model control points.

4. The method according to claim 1, wherein step b) comprises ignoring locations for which the metric function returns a similarity value below the similarity metric threshold.

5. The method according to claim 4, wherein at locations where the metric function returns a similarity value below the similarity metric threshold, the geologic model is adjusted via interpolation between at least one of model guide points and model control points.

6. The method according to claim 1, wherein step b) comprises, via said metric function, comparing separate candidate traces with a plurality of model control points and producing a model guide point at a point of any candidate trace where the metric function results in a highest similarity value, if above said similarity metric threshold.

7. The method according to claim 1, wherein the initial model estimate is one of the following:
a geometric surface;
a geologic surface; and
a geologic model.

8. The method according to claim 2, wherein the data search window in time or depth is fixed laterally.

9. The method according to claim 2, wherein the data search window in time or depth varies laterally.

10. The method according to claim 2, wherein determining the data search window is based on a fixed or spatially varying model uncertainty envelope.

11. The method according to claim 2, wherein a control trace is windowed or otherwise preprocessed.

12. The method according to claim 2, wherein the geologic data within the data search window is windowed or otherwise preprocessed.

13. The method according to claim 1, wherein the metric function satisfies the conditions of a mathematical norm.

14. The method according to claim 1, wherein the metric function is based on waveform correlation.

15. The method according to claim 1, the method comprising:
c) adding additional model control points after step a) and step b), and adjusting the geologic model towards or onto such additional model guide points.

16. The method according to claim 15, wherein step c) comprises filtering said additional model control points by proximity to a known region before adjusting the geologic model in step c).

17. The method according to claim 16, wherein the filtering region is specified by a masking polygon.

18. The method according to claim 16, wherein the filtering region is a specified range from a surface intersection, such as a fault or other geologic surface.

19. The method according to claim 10, wherein the data search window is a function of the model uncertainty envelope.
